(19) United States
(12) Patent Application Publication
(10) Pub. No.: US 2025/0130044 A1
(43) Pub. Date: Apr. 24, 2025

(54) AUXILIARY GYROSCOPE APPROACH FOR BALANCED PERFORMANCE VIA GYRO SELF-CALIBRATION

(71) Applicant: CALIFORNIA INSTITUTE OF TECHNOLOGY, PASADENA, CA (US)

(72) Inventor: Yong LIU, San Marino, CA (US)

(21) Appl. No.: 18/902,575

(22) Filed: Sep. 30, 2024

Related U.S. Application Data
(60) Provisional application No. 63/545,257, filed on Oct. 23, 2023.

(51) Int. Cl. G01C 19/5776; G01C 25/00

(52) U.S. Cl. CPC G01C 19/5776; G01C 25/005

(57) ABSTRACT

Methods and devices for bias gyroscopes self-calibration are disclosed. The described teachings can be applied to inertial measurement units implementing one or more auxiliary Coriolis Vibratory Gyroscope (CVG) in conjunction with one or more primary gyroscopes. The auxiliary CVG, capable of mode-switching, enables continuous bias estimation for both its own operation and those of the primary gyroscopes without relying on external aiding sensors. The disclosed methods implement a Kalman filter for bias estimation and can update estimates either at every measurement time step or at mode switching intervals. By combining the good noise performance of primary gyroscopes with the bias stability improvement from the auxiliary CVG, an enhanced overall performance can be achieved.

### CROSS REFERENCE TO RELATED APPLICATIONS

The present application claims priority to U.S. Prov. App. 63/545,257 filed on Oct. 23, 2023, and is related to published paper “Liu, John Y.-Auxiliary Gyroscope Approach for Balanced Performance via Gyro Self-Calibration-IEEE International Symposium on Inertial Sensors and Systems-March 2024” all of which are incorporated herein by reference in their entirety.

### STATEMENT OF GOVERNMENT GRANT

This invention was made with government support under Grant No. 80NMO0018D0004 awarded by NASA (JPL). The government has certain rights in the invention.

### FIELD

The present disclosure is related to gyroscope systems implementing mode-switching gyroscopes as an auxiliary sensor to a primary gyroscope for bias self-calibration purpose.

### BACKGROUND

Throughout this document, the terms “gyro” and “gyroscope” are used interchangeably.

Throughout this document, the term “mode-switching gyroscope” refers to a type of gyroscope that can operate in multiple modes, typically switching between actuating and sensing configurations to gain bias observability for various applications. In contrast, the term “single-mode gyroscope” is a gyroscope that operates in only one mode or configuration. Unlike mode-switching gyroscopes, these single-mode devices are designed to operate with fixed configurations and in particular cannot make their biases observable by operational configuration changes of the device itself.

In many space and terrestrial applications, high-performance Inertial Measurement Unit (IMU) is employed for navigation purpose. Generally, an IMU is aided by external sensors so that the IMU performance degradation is limited. For navigation solutions without any external aiding sensors, the performance has to rely on an IMU's intrinsic performance, or some calibration measure has to be incorporated. [reference 1] provides such an application in which long-term navigation solution is needed based on IMU propagation only without any external aiding sensors.

In an IMU-only based navigation solution, the gyroscope performance in terms of noise and bias are often performance limiting factors in navigation systems and a gyroscope unit with good performance on both noise and bias is usually very expensive and has undesirable size, weight, and power (SWaP). As gyro bias and its growth produce large attitude errors, the techniques and approaches for gyro bias self-calibration during normal operation without any external aiding sensors become very helpful.

Bias self-calibration is possible for certain types of gyroscopes, namely the Coriolis Vibratory Gyro (CVG), based on the so-called mode-switching technique [reference 2]-[reference 3]. It is perceived that multiple CVGs operating in parallel with periodic mode-switching can calibrate the gyro biases while continuing provide non-stop real-time angular rate measurements. A study [reference 4] describes test results and filtering methods for a pair of Hemispherical Resonator Gyroscopes (HRGs). The researchers used an alternating mode-switching scheme between the two HRGs, which allowed for simultaneous bias calibrations under specific test conditions.

Meanwhile, Micro Electro Mechanical Systems (MEMS) Coriolis Vibratory Gyroscopes (CVGs), such as Disc Resonator Gyroscopes (DRGs) [reference 2], offer several advantages. They are compact, cost-effective, and possess the same bias self-calibration capability as HRGs. Given these benefits, investigating the use of self-calibrating MEMS CVGs in practical applications appears to be a promising avenue of research.

### SUMMARY

The disclosed methods and devices integrate two different types of gyroscopes, i.e., a main gyroscope, and an auxiliary gyroscope, specifically a CVG. The goal of such integration is to enable self-calibration of biases for both gyroscopes under dynamic conditions, without relying on external aiding sensors for assistance. The resulting benefit of this combined system is to maintain the superior noise performance of the main gyroscope, while significantly reducing or eliminating the bias in the angular rate measurements of the combined system. The described devices leverage the observabilities of the biases of all gyros in the system enabled by a single (or more) auxiliary gyros(s) and the property of noise averaging of large number of bias calibrated gyros to provide gyro systems with greatly improved performance in both bias and noise.

This self-calibration capability with a single-mode primary gyro, i.e. a primary gyro that cannot switch modes, relies on the key insight that the biases of the primary gyro and auxiliary gyro can be made observable and therefore calibratable, while the gyro system provides non-interrupted measurements for real applications.

The disclosed methods of employing one or more primary and one or more auxiliary gyros as a gyro system provide several advantages. One is the balanced achievable performance. In one scenario, the primary gyroscope is known for its good angular noise performance, while the auxiliary gyroscope has the capability for bias self-calibration. By utilizing the self-calibration feature of the auxiliary gyroscope, the bias stability of the primary gyroscope can be substantially improved. This combination results in a system that achieves both low noise and high bias stability simultaneously and the result is a more accurate and reliable gyroscopic system that overcomes the individual limitations of each component. In another scenario, multiple primary gyros, with their biases calibrated, can be used to reduce the noise of the gyro system. The other advantage is the cost. Unlike the case of employing two expensive CVGs, inexpensive single-mode MEMS gyros can be used as the primary gyros and one or more MEMS CVGs can potentially serve as the auxiliary gyro, acting as the self-contained “aiding” sensors to improve the bias performance of the combined system.

According to a first aspect of the present disclosure, a gyroscope system is provided, comprising: a primary gyroscope and an auxiliary gyroscope, the primary gyroscope being a single-mode gyroscope, and the auxiliary gyroscope being a mode-switching gyroscope, and a bias estimator configured to: receive measurements from the primary gyroscope and the auxiliary gyroscope at measurement time steps; estimate biases of the primary gyroscope and the auxiliary gyroscope based on the measurements and a mode switching time of the auxiliary gyroscope to provide estimated bias, and based on the estimated bias, output an angular velocity measurement for the primary gyroscope.

According to a second aspect of the present disclosure, an inertial measurement unit is provided, comprising: a plurality of primary gyroscopes; at least one auxiliary gyroscope being a mode-switching gyroscope, and a bias estimator configured to: receive measurements from the plurality of primary gyroscopes and the at least one auxiliary gyroscope at measurement time steps; estimate biases of the plurality of primary gyroscopes and the at least one auxiliary gyroscope based on the measurements and the mode-switching time of the at least one auxiliary gyroscope to provide an estimated bias; based on the estimated biases, correct and output angular velocity measurements for the at least one auxiliary gyroscope, and the plurality of primary gyroscopes, and based on weighted averaging of the bias-corrected angular velocity measurements for the at least one auxiliary gyroscope, and the plurality of primary gyroscopes, output a single angular velocity measurement for the inertial measurement unit system.

According to a third aspect of the present disclosure, a method for self-calibrating a gyroscope system is disclosed, the method comprising: receiving measurements from a primary gyroscope, the primary gyroscope being a single-mode gyroscope; receiving measurements from an auxiliary gyroscope, the auxiliary gyroscope being a mode-switching gyroscope; switching the auxiliary gyroscope between at least two modes at predetermined intervals; estimating biases of the primary gyroscope and the auxiliary gyroscope based on received measurements and mode-switching of the auxiliary gyroscope, and outputting corrected angular velocity measurements for the primary gyroscope, and the auxiliary gyroscope.

Further aspects of the disclosure are provided in the description, drawings and claims of the present application.

### DESCRIPTION OF THE DRAWINGS

FIG. 1A shows an inertial measurement setup according to an embodiment of the present disclosure.

FIG. 1B shows a block diagram representing an exemplary implementation of gyroscope bias estimation according to an embodiment of the present disclosure.

FIG. 2A shows a typical timeline of the switching scheme for the two CVG gyros.

FIGS. 2B-2C show exemplary measurement timelines of primary and auxiliary gyroscopes according to an embodiment of the present disclosure.

FIGS. 3A-3B show exemplary charts illustrating exemplary performances of the disclosed methods and devices.

### DETAILED DESCRIPTION

The following nomenclature will be adopted throughout the present disclosure:
ω,Ω=angular rate
ωₘ=angular rate measurement
ωₙ=CVG vibration axis natural frequency
Δω=CVG vibration axis natural frequency imbalance
τ=CVG vibration axis damping constant

$$Δ ( \frac{1}{τ} )$$

=CVG vibration axis damping imbalance
b=gyro bias
n=gyro noise
[symbol] [ ].=expected value
var[ ].=variance
cov[ ].=covariance
μ[ ]=time average
Φ_{arw}=gyro angle random walk noise PSD
Φ_{rrw}=gyro rate random walk noise PSD
m=mass

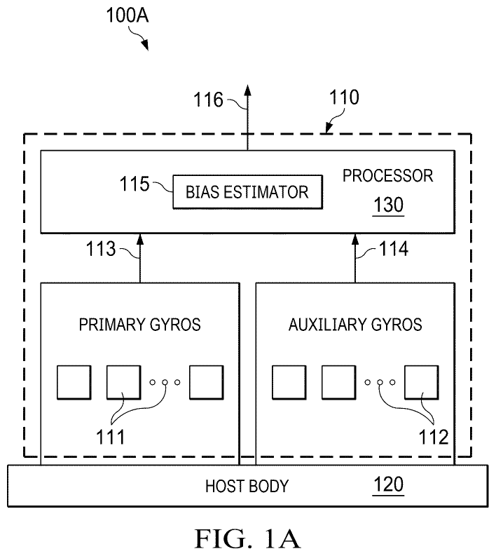

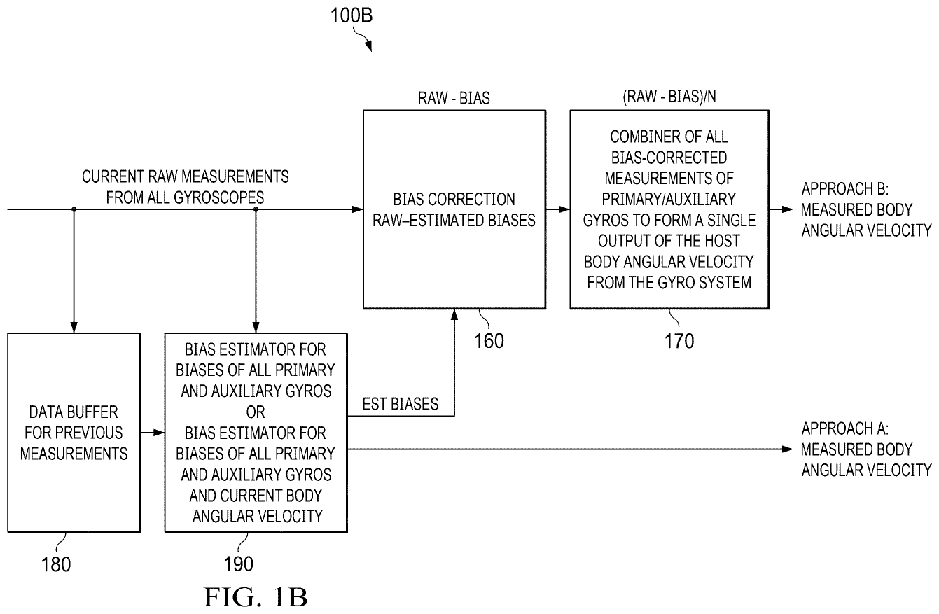

FIG. 1A shows an inertial measurement setup (100A) according to an embodiment of the present disclosure. Measurement setup (100A) comprises IMU (110) implemented to measure the body angular velocity of host body (120). IMU (110) comprises one or more primary gyroscopes (111), one or more auxiliary gyroscopes (112), and a processor (130) outputting, as indicated by arrow (116), the estimated angular velocity of host body (120). Processor (130) comprises bias estimator (115) receiving measurements, as indicated by arrows (113, 114), from both sets of gyroscopes (111, 112) to perform bias estimation. According to an embodiment of the present disclosure, primary gyroscopes (111) may include a combination of single-mode and mode-switching gyroscopes. In preferred embodiments, primary gyroscopes (111) include only single-mode switching gyroscopes meaning that they may not be capable of switching modes. According to further embodiments of the present disclosure, auxiliary gyroscopes (112) are mode-switching gyroscopes.

FIG. 1B shows block diagram (100B) representing an exemplary implementation of processor (130) of FIG. 1A, in accordance with the teachings of the present disclosure. As shown, such implementation includes two different approaches, i.e. approach A and approach B, to estimate the body angular velocity. The raw measurements from all gyroscopes, i.e., all primary and auxiliary gyros, are first saved in date buffer (180) for current and future bias angular velocity estimations. The current raw measurements and a portion of previous measurements (via data buffer (180)) are then fed to bias estimating element (190) to estimate the gyro biases. In approach A, using such biases, the angular velocity is then directly estimated and output. In approach B, bias correction (160) is performed by subtracting the bias estimated from the raw measurements. The resulting corrected data is then averaged (170) over the current and a portion of previous measurements. The resulting average bias estimates are then used to calculate the body angular velocity which will be then output. According to the teachings of the present disclosure, approach A is more beneficial in scenarios where some information about the motion of the host body is available, e.g. a spacecraft that does not rotate. In other scenarios that such additional information is not available, approach B offers a better performance compared to approach A. Further details on how the averaging process (170) incorporates both current and previous measurements will be explained later in this disclosure.

In order to further describe the functionality of IMU (110) in more detail, some fundamental concepts related to the operation of switching-mode gyroscopes are provided in the next few paragraphs.

A CVG can be described by a two-dimensional vibration model [reference 5]-[reference 6] in modal form as follows:

$$\ddot{x} - k ( 2 Ω \dot{y} + \dot{Ω} y ) + \frac{2}{τ} \dot{x} + Δ ( \frac{1}{τ} ) ( \dot{y} sin 2 {θ}_{τ} + \dot{x} cos 2 {θ}_{τ} ) + ( {ω}^{2} - {k}^{′} {Ω}^{2} ) x - ω Δ ω ( x cos 2 {θ}_{ω} + y sin 2 {θ}_{ω} ) = {f}_{x} + {γ}_{x} {g}_{x} + ( {ω}^{2} - {k}^{′} {Ω}^{2} ) y + ω Δ ω ( y cos 2 {θ}_{ω} - x sin 2 {θ}_{ω} ) = {f}_{y} + {γ}_{y} {g}_{y} \qquad ( 1 )$$

where the asymmetric terms in frequency and damping are defined as

$$\{ \begin{matrix}{ω}^{2} = \frac{{ω}_{1}^{2} + {ω}_{2}^{2}}{2} \\ ωΔω = \frac{{ω}_{1}^{2} - {ω}_{2}^{2}}{2} \\ \frac{1}{τ} = \frac{1}{2} ( \frac{1}{{τ}_{1}} + \frac{1}{{τ}_{2}} ) \\ Δ ( \frac{1}{τ} ) = \frac{1}{{τ}_{1}} - \frac{1}{{τ}_{2}}\end{matrix} \qquad ( 2 )$$

and x and y are the position of the element in the gyroscope with respect to the X-axis and Y-axis, \dot{x}, \dot{y}, \ddot{x} and ÿ are the first and second order time derivative of x and y, Ω is the angular velocity of the gyroscope with respect to an inertial frame of reference, k and k′ are two gain parameters, τ₁ and τ₂ are the two damping constants for the two axes respectively, with τ being their average, ω₁ and ω2 are the two natural frequencies for the two axes respectively, with ω being their average, A denotes the difference, Or is the azimuth of the τ₁ damping axis with respect to the X-axis (maybe also referred to as the damping azimuth angle), θ_{ω} is the azimuth of the ω₁ natural frequency of vibration axis with respect to the X-axis, fₓ and f_{y} are the external force components exerted on the element along the X-axis and Y-axis respectively, gₓ and g_{y} are linear accelerations of the frame in the X-axis and Y-axis directions and γₓ and γ_{y} are the two gains to map the frame accelerations into the element accelerations.

From [reference 2], several types of errors in a CVG can generate biases in the output of the gyro. Most often, thermal dependency of those mechanical errors can produce time-varying biases that are typically captured by gyro bias repeatability characteristics. [Reference 3] provides some details as to how intrinsic errors in a CVG would contribute to the bias of the CVG under the condition of zero input angular rate and non-zero input. Some basic results of [reference 3] including the basis for the zero rate and in-situ gyro bias self-calibration are described in the next few paragraphs. The mechanical error terms in a CVG are (1) drive and sense axis frequency mismatch, (2) drive and sense axis damping mismatch, (3) drive axes misalignment uncertainty, (4) sense axes misalignment uncertainty, (5) normal mode axis azimuth angle, and (6) damping axis azimuth angle.

In order to address the drive and sense axes alignment offset and alignment stability, it can be assumed that the two axes force are applied with directional errors, i.e.

$$[ \begin{matrix}{f}_{x , act} \\ {f}_{y , act}\end{matrix} ] = [ \begin{matrix}1 & a \\ b & 1\end{matrix} ] [ \begin{matrix}{f}_{x} \\ {f}_{y}\end{matrix} ] = E ( a , b ) [ \begin{matrix}{f}_{x} \\ {f}_{y}\end{matrix} ] \qquad ( 3 )$$

where f_(x,act) and f_(y,act) are the actual accelerations exerted on the element along the X-axis and Y-axis, a and b are misalignment of the exerting force (acceleration) directions. In case the gyroscope is driven to vibrate along an axis between the X-axis and the Y-axis with a drive angle ϕ, the drive axis and the sense axis that is substantially orthogonal to the drive axis form a rotated frame from the reference formed by the X-axis and Y-axis as follows:

$$[ \begin{matrix}x \\ y\end{matrix} ] = [ \begin{matrix}cos ϕ & - sin ϕ \\ sin ϕ & cos ϕ\end{matrix} ] [ \begin{matrix}{x}_{s} \\ {y}_{s}\end{matrix} ] = M ( ϕ ) [ \begin{matrix}{x}_{s} \\ {y}_{s}\end{matrix} ]$$

The set of equations identified in operation includes a first equation for an in-phase bias and a second equation for an in-quadrature bias. The in-phase bias and the in-quadrature bias are given by the following equation:

$$\frac{{B}_{in - phase}}{- {c}_{0} {ω}_{x}} = Δ ( \frac{1}{τ} ) sin ( 2 ϕ - 2 {θ}_{τ} ) \qquad ( 4 )$$

$$\frac{{B}_{in - quad}}{{c}_{0}} = - ( 1 + a ) ω Δ ω sin ( 2 ϕ - 2 {θ}_{ω} ) + \frac{a + b}{4} ωΔω cos ( 2 ϕ + 2 {θ}_{ω} ) - \frac{a}{ab - 1} ωΔω cos ( 2 {θ}_{ω} )$$

where c₀ is the amplitude component in phase with the drive axis.

For a CVG operating under dynamic condition (non-zero angular rate), the drive axis vibration excitation is controlled using an Automatic Gain Control (AGC) loop and the angular rate measurement is derived from the force rebalance control term. Under the assumptions of perfect AGC in the drive axis and perfect force rebalance control in the sensing axis, the force rebalance term is (ignore 2nd and higher-order terms) [reference 3]

$$\frac{{S}_{frb}}{{\dot{x}}_{s} ( t )} = - Δ ( \frac{1}{τ} ) sin ( 2 ϕ - 2 {θ}_{τ} ) - \frac{( b - a ) + ( a + b ) cos ( 2 ϕ )}{τ} + ( ( a + b ) sin ( 2 ϕ ) + 2 ) k Ω := G ( Ω , ϕ ) \qquad ( 5 )$$

where xₛ(t)=c₀ cos (ωₛt) is AGC controlled oscillation and \dot{x}ₛ(t)=−ωₛc₀ sin (ωₛt) as its rate. If the force rebalance signal is modulated using \dot{x}ₛ(t), then one can obtain

$$[ {S}_{frb} ] {\dot{x}}_{s} ( t ) = G ( Ω , ϕ ) {( {ω}_{s} {c}_{0} )}^{2} ( \frac{1 - cos ( 2 {ω}_{s} t )}{2} )$$

The gyro measurement output is defined as

$$Y ( ϕ ) = \frac{2 Mag ( [ {S}_{frb} {\dot{x}}_{s} ( t ) )}{2 {k ( {ω}_{s} {c}_{0} )}^{2}} = Ω + Δ Ω$$

where the gyro measurement error is

$$ΔΩ := \frac{1}{2 k} [ - Δ ( \frac{1}{τ} ) sin ( 2 ϕ - 2 {θ}_{τ} ) - \frac{( b - a ) + ( a + b ) cos ( 2 ϕ )}{τ} + ( a + b ) sin ( 2 ϕ ) k Ω ] \qquad ( 6 )$$

It is clear from Eq. (6) above that if the drive angle direction is switched from ϕ=0 to ϕ=90°, the bias terms

$$- \frac{1}{2 k} Δ ( \frac{1}{τ} ) sin ( 2 ϕ - 2 {θ}_{τ} ) and - \frac{1}{2 k} \frac{( a + b ) cos ( 2 ϕ )}{τ}$$

will switch sign. The pure bias term

$$- \frac{1}{2 k} \frac{( b - a )}{τ}$$

is a switch angle independent. The scale factor term

$$\frac{1}{2} ( a + b ) sin ( 2 ϕ ) Ω$$

has a pure sign switch when the angular rate 22 stays the same but is more complex when the angular rate changes in a dynamic environment. In Coriolis Vibratory Gyroscopes CVGs, a component of the intrinsic bias exhibits sign reversal upon alteration of drive angle directions. This is known as mode switching. Exploiting this characteristic, measurements obtained from a CVG at varying drive angles can be used to derive an estimate of the intrinsic bias. This methodology, referred to as the self-calibration approach, facilitates the implementation of corrective measures to mitigate the effects of intrinsic bias. Throughout the disclosure, the intrinsic biases that switch signs and are not input rate dependent are the focus.
Gyro System with Two CVGs

The following expression represents a single-axis gyro measurement model for two perfectly co-aligned CVGs:

$${ω}_{1 , m} ( t ) = ω ( t ) + {b}_{1} ( t ) + {n}_{1 , arw} ( t )$$

where b₁, b₂ are gyro intrinsic biases of the two gyros and n_{1,arw}, n_{2,arw} are the gyro angle random walk noises, with [symbol] [n_{1,arw}(t)n_{1,arw}(s)]= [symbol] [n_{2,arw}(t)n_{2,arw}(s)]=δ(t−s)Φ_{arw}. For simplicity reasons in demonstrating gyro self-calibration results, the gyro biases may be described by a rate random walk (RRW) model, i.e.

$${\dot{b}}_{1} = {n}_{1 , r r w} ( t ) \qquad ( 8 )$$

$${\dot{b}}_{2} = {n}_{2 , r r w} ( t )$$

where [symbol] [n_{1,rrw}(t)n_{1,rrw}(s)]= [symbol] [n_{2,rrw}(t)n_{2,rrw}(s)]=δ(t−s)Φ_{rrw}. It is noted that results similar to those reported in this paper can be obtained if the bias from gyro bias instability is added to Eq. (8) using a Gauss-Markov process, in addition to the simple RRW white noise.
   Gyro Measurements with Mode Switching

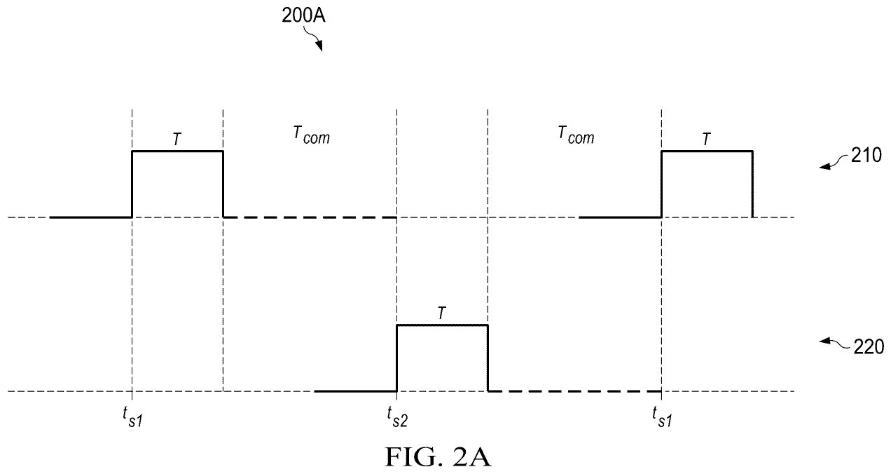

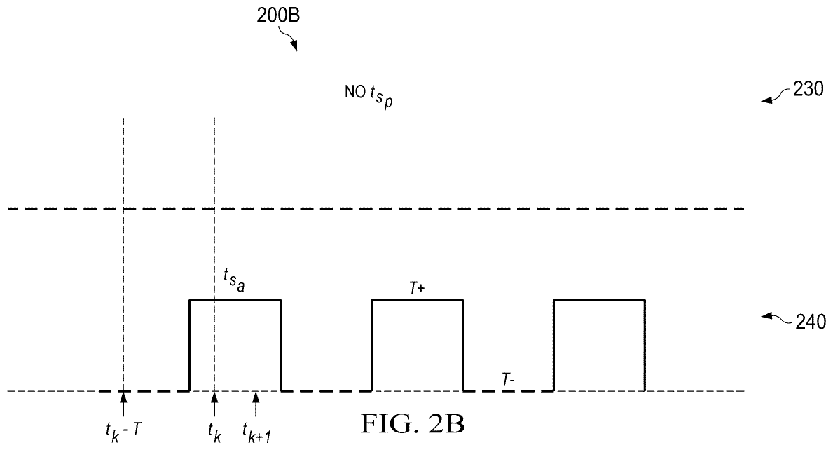

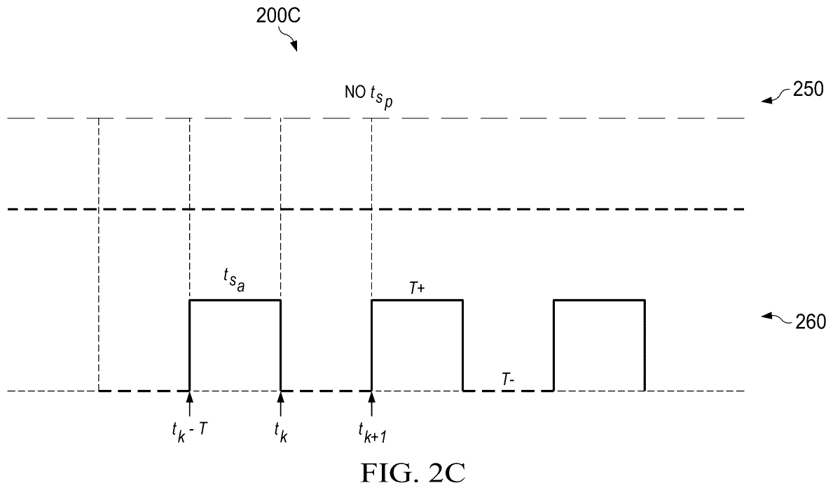

In the context of bias self-calibration utilizing the internal switch mode, one can formulate a bias estimation model by leveraging measurements obtained from two consecutive mode switch operations. FIG. 2A shows a typical timing diagram (200A) of the switching scheme for the two CVG gyros, where T is the self-calibration period and T_{com} is the time when both gyros provide valid measurements. Timelines (210, 220) correspond to a first and a second CVG, respectively. Time instants (tₛ₁, tₛ₂) represent, each, the starting time for switching the corresponding gyroscopes.

With the mode switching properties of biases for CVG gyros described earlier, the switching logic described in FIG. 1A produces the measurements of the two CVGs as

$${ω}_{1 , m} ( t ) = \{ \begin{matrix}ω ( t ) - {b}_{1} ( t ) + {n}_{1 , arw} ( t ) ; & ∀ t ∈ [ {t}_{{s}_{1}} , {t}_{{s}_{1}} + T ] \\ ω ( t ) + {b}_{1} ( t ) + {n}_{1 , arw} ( t ) ; & ∀ t ∈ otherwise\end{matrix} \qquad ( 9 )$$

$${ω}_{2 , m} ( t ) = \{ \begin{matrix}ω ( t ) - {b}_{2} ( t ) + {n}_{2 , arw} ( t ) ; & ∀ t ∈ [ {t}_{{s}_{2}} , {t}_{{s}_{2}} + T ] \\ ω ( t ) + {b}_{2} ( t ) + {n}_{2 , arw} ( t ) ; & ∀ t ∈ otherwise\end{matrix}$$

where tₛ_{₁} and tₛ_{₂} are the predetermined mode switching times for the first and the second gyro, respectively, with tₛ_{₂}-tₛ_{₁}>T for separation purpose. It can be noticed that the common time window for non-switched measurements for both gyros is T_{com}=Tₛ_{₂}−Tₛ_{₁}−T. The following two equal size time windows can now be defined as:

$${T}_{i -} = \{ t ∈ [ {t}_{{s}_{i}} - T , {t}_{{s}_{i}} ) \} \qquad ( 10 )$$

$${T}_{i +} = \{ t ∈ [ {t}_{{s}_{i}} , {t}_{{s}_{i}} + T ) \}$$

for i=1, 2 (corresponding to the first and the second gyro switching switching). Assumption may be made that b₁(t) and b₂(t) are slowly time-varying relative to the gyro switching time window size T. As a result, approximations such as b₁≈b₁(T₁₋)≈b₁ (T₁₊) and b₂≈b₂ (T₁₋)≈b₂ (T₁₊) will be reasonable. Such approximations will be used throughout the rest of the disclosure.
Bias Measurements with Mode Switching

For any two arbitrary time instants before and after the mode switching time of the first gyro, t₋∈T₁₋ and t₊∈T₁₊, the slowly time-varying bias assumption leads to following measurement equations for the two gyros

$${ω}_{1 , m} ( {t}_{-} ) = ω ( {t}_{-} ) + {b}_{1} ( {t}_{-} ) + {n}_{1 , arw} ( {t}_{-} ) \approx ω ( {t}_{-} ) + {b}_{1} + {n}_{1 , arw} ( {t}_{-} ) \qquad ( 11 )$$

$${ω}_{1 , m} ( + ) = ω ( {t}_{+} ) - {b}_{1} ( {t}_{+} ) + {n}_{1 , arw} ( + ) \approx ω ( + ) - {b}_{1} + {n}_{1 , arw} ( {t}_{+} )$$

$${ω}_{2 , m} ( {t}_{-} ) = ω ( {t}_{-} ) + {b}_{2} ( {t}_{-} ) + {n}_{2 , arw} ( {t}_{-} ) \approx ω ( {t}_{-} ) + {b}_{2} + {n}_{2 , arw} ( {t}_{-} )$$

$${ω}_{2 , m} ( {t}_{+} ) = ω ( {t}_{+} ) + {b}_{2} ( {t}_{+} ) + {n}_{2 , arw} ( {t}_{+} ) \approx ω ( {t}_{+} ) + {b}_{2} + {n}_{2 , arw} ( {t}_{-} )$$

There are four unknowns and 4 independent variables in Eq. (11). The assumed constant biases for the two gyros within a small time window can be solved completely independent of the truth rate

$$[ \begin{matrix}{b}_{1 , {s}_{1}} \\ {b}_{2 , {s}_{1}}\end{matrix} ] = {\underbrace{\frac{1}{2} [ \begin{matrix}1 & - 1 & - 1 & 1 \\ - 1 & - 1 & 1 & 1\end{matrix} ]}}_{{H}_{ω , {s}_{1}}} {\underbrace{[ \begin{matrix}{ω}_{1 , m} ( {t}_{-} ) \\ {ω}_{1 , m} ( {t}_{+} ) \\ {ω}_{2 , m} ( {t}_{-} ) \\ {ω}_{2 , m} ( {t}_{+} )\end{matrix} ]}}_{{ω}_{{s}_{1}}} + {\underbrace{\frac{1}{2} [ \begin{matrix}- 1 & 1 & 1 & - 1 \\ 1 & 1 & - 1 & - 1\end{matrix} ]}}_{{H}_{η , {s}_{1}}} {\underbrace{[ \begin{matrix}{n}_{1 , arw} ( {t}_{-} ) \\ {n}_{1 , arw} ( {t}_{+} ) \\ {n}_{2 , arw} ( {t}_{-} ) \\ {n}_{2 , arw} ( {t}_{+} )\end{matrix} ]}}_{{η}_{{s}_{1}}} \qquad ( 12 )$$

Similarly, for any two arbitrary time instants before and after the mode switching time of the second gyro, i.e. t₋∈T₂₋ and t₊∈T₂_{⁺}, the same slowly time-varying bias assumptions leads to the following gyro bias measurements for the two gyros

$$[ \begin{matrix}{b}_{1 , {s}_{2}} \\ {b}_{2 , {s}_{2}}\end{matrix} ] = {\underbrace{\frac{1}{2} [ \begin{matrix}1 & - 1 & - 1 & 1 \\ - 1 & - 1 & 1 & 1\end{matrix} ]}}_{{H}_{ω , {s}_{1}}} {\underbrace{[ \begin{matrix}{ω}_{1 , m} ( {t}_{-} ) \\ {ω}_{1 , m} ( {t}_{+} ) \\ {ω}_{2 , m} ( {t}_{-} ) \\ {ω}_{2 , m} ( {t}_{+} )\end{matrix} ]}}_{{ω}_{{s}_{1}}} + {\underbrace{\frac{1}{2} [ \begin{matrix}- 1 & 1 & 1 & - 1 \\ 1 & 1 & - 1 & - 1\end{matrix} ]}}_{{H}_{η , {s}_{1}}} {\underbrace{[ \begin{matrix}{n}_{1 , arw} ( {t}_{-} ) \\ {n}_{1 , arw} ( {t}_{+} ) \\ {n}_{2 , arw} ( {t}_{-} ) \\ {n}_{2 , arw} ( {t}_{+} )\end{matrix} ]}}_{{η}_{{s}_{1}}} \qquad ( 12 )$$

For two CVGs operating in real-time, the bias measurements from Eq. (12) and (13) establish the basis for gyro intrinsic bias estimation by alternating the mode switching between the two CVGs. As it is easily seen, the estimation accuracy depends on the validity of the slowly varying bias assumption, the size of the switching window and the gyro angle random walk (ARW) noise.

In order to address the ARW noise's effect on the bias measurement accuracy, the time averages of Eq. (12) and Eq. (13) over the two time windows T_{i,-} and Tᵢ₊, i=1, 2 may be taken:

$$[ \begin{matrix}{\overline{b}}_{1 , {s}_{i}} \\ {\overline{b}}_{2 , {s}_{i}}\end{matrix} ] = [ \begin{matrix}μ [ {b}_{1 , {s}_{i}} ] \\ μ [ {b}_{2 , {s}_{i}} ]\end{matrix} ] = {H}_{ω , {s}_{i}} μ [ {ω}_{{s}_{i}} ] + {H}_{η , {s}_{i}} μ [ {η}_{{s}_{i}} ] \qquad ( 14 )$$

where

$$μ [ . ] = \frac{1}{T} {\int }_{0}^{T} [ . ] dt$$

denotes the time average of signal [.] over the time window T. Assumption can be made on the ARW noise of the two gyros being the same and stationary. The variance of the time average of the ARW noise over T_{i±}, i=1, 2 would be the same and is given by

$$var [ μ [ {n}_{i , arw} ( {t}_{\pm } ) ] ] = \frac{1}{T} {Φ}_{arw}$$

where i=1, 2. The covariance of the bias measurement errors given by Eq. (14) can then be easily calculated as

$$cov [ μ [ {η}_{{s}_{i}} ] ] = {{H}_{η , {s}_{i}} ( var [ μ [ {n}_{i , arw} ( {t}_{\pm } ) ] ] {I}_{4 \times 4} ) [ {H}_{η , {s}_{i}} ]}^{T} = \frac{{Φ}_{arw}}{T} {I}_{2 \times 2} \qquad ( 15 )$$

Therefore, the errors of the two bias measurements are uncorrelated ARW noise improved by noise averaging.

There are different methods to construct the two cases of bias measurements corresponding to the two CVG's mode switching for the purpose of estimating the gyro system's angular rate. The choice of the strategy may depend on the relative level of the gyro errors. As the measurements given by Eq. (14) utilize the real-time gyro measurements in the entire time windows of size T before and after the respective mode switching time t_{s,}_{ᵢ}=1, 2, a natural choice of updating time for the gyro bias estimation purpose would be at the end of corresponding mode switching time t=tₛ_{ᵢ}+T, i.e.

$$[ \begin{matrix}{\overline{b}}_{1 , {s}_{i}} \\ {\overline{b}}_{2 , {s}_{i}}\end{matrix} ] = [ \begin{matrix}{\overline{b}}_{1 , {s}_{i}} ( {t}_{{s}_{i}} + T ) \\ {\overline{b}}_{2 , {s}_{i}} ( {t}_{{s}_{I}} + T )\end{matrix} ] = {H}_{ω , {s}_{i}} μ [ {ω}_{{s}_{i}} ] + {H}_{η , {s}_{i}} μ [ {η}_{{s}_{i}} ] \qquad ( 16 )$$

for i=1, 2.

There is an apparent trade between the time it takes for noise averaging and how quickly we need to track the bias changes in real time. If biases change more quickly, as the validity of the slowly time-varying bias may be in question, the time delay between t₊ and t₋ for bias measurement purpose may be minimized. In the cases where the ARW noise is dominant, minimizing its effect on the accuracy of the bias measurements may require longer averaging time. In that case, using the average of ω_{1,m} and ω_{2,m} over longer time windows can be helpful.

Different from the previous approach of using two mode-switching CVGs for self-calibrating their respective biases while provide real-time angular rate measurements, the teachings of the present disclosure provide the possibility and design considerations for a mode switchable CVG to act as an auxiliary gyro that provides bias self-calibration for itself and for a primary single-mode gyro. According to the embodiments of the present disclosure mode switching does not need to occur on both gyros for the biases of both gyros to be observable. This fact provides the basis for an approach of supplementing one or more existing single-mode gyro with one or more mode switchable auxiliary CVGs for the purpose of constantly calibrating the primary gyro bias. The structure shown in FIG. 1A represents such an approach.

The concept of combining auxiliary gyros with primary ones as disclosed, provide design flexibilities in choosing a primary gyro that already has very good noise performance, but with less desirable bias instability or ARW characteristics. In applications where the biases are not easily calibrated with external aiding sensors, using a less expensive CVG as the auxiliary gyro may provide a means to improve the primary gyro bias performance while retaining the good ARW performance. Another use case might be in a situation where an array of low performance gyros is used to provide an aggregated angular rate measurement, the single auxiliary CVG can self-calibrate the biases of all primary gyros before they can be combined in some optimal way to form the gyro system output. In the next few paragraphs, for the sake of simplicity, a system consisting of one primary and one auxiliary gyro is considered. However, the related teachings apply more general system as shown in FIG. 1A where two or more auxiliary gyros can be implemented with two or more primary gyroscope.

With reference to FIG. 1A, in an embodiment, the one or more primary gyroscopes (111) include one primary gyro P and an the one more auxiliary gyroscopes (112) includes one auxiliary gyro A. In what follows, it is also assumed that gyro A is mode-switching (can be less expensive and smaller size). In a further embodiment, gyro A is continuously engaged in the periodical mode switched with the switch time T, while gyro P operates regularly without any switching. According to the teachings of the present disclosure, there are two ways (described by a first and a second embodiment in below) where the mode-switching auxiliary gyro measurements are used in the estimator and the possibility of trading ARW and bias stability.

Continuing with FIG. 1A and in the first embodiment, the estimator (115) simultaneously estimates the two gyro biases. FIG. 2B shows a timing diagram (200B) including timelines (230, 240) corresponding to measurement timelines of the primary and auxiliary gyroscopes, respectively. As can be seen, there is no switching in the case of the primary gyroscope. In this first case, estimator (115) of FIG. 1A may be updated at every native time step with measurements of the two gyros at the current time step and the time step T seconds before the current time. This can be performed regardless of which mode the auxiliary gyro is in currently, ensuring a continuously executed self-calibration process. As the measurements at instants tₖ and tₖ−T are used to create the bias measurements at ty, the scheme can potentially have a delay of T in catching up the most recent true gyro biases in the two gyros. Time instants (tₖ, tₖ₊₁) of FIG. 2B, represent two consecutive native time steps of both the primary and the auxiliary gyroscopes. These are examples of the time instants when the measurements are taken by each gyro.

Continuing with FIG. 1A and in the second embodiment, the estimator (115) of FIG. 1A is updated at the auxiliary gyro mode switching time and takes the gyro measurements from the current mode window T and the previous mode window T. This is demonstrated in FIG. 2C showing timing diagram (200C) which includes timelines (250, 260) showing timelines of the primary and auxiliary gyroscopes, respectively. As shown, time instants (tₖ−T, tₖ, tₖ) are examples showing the time instants when the measurement are taken by both gyroscopes. Such time instants coincide with the rising or falling edge of switching modes.

For both cases, i.e. the first and the second embodiment as described above, it can be observed that the estimators can be updated regardless which mode or which mode boundary the current time is at, thus a persistent self-calibration process can be carried out. In that regard, the two schemes only differ in the estimator updating frequency. Other embodiments can be envisaged wherein estimator updates occur at every native time step, but the previous mode data is taken as the average of the samples within the time window. That approach provides a compromise between the two schemes considered described in relation to the first and the second mentioned above.

With continued reference to FIG. 1A, bias estimator (115) may be implemented using a Kalman filter, according to the teachings of the present disclosure. As such, the combined angular rate from the gyro system can also be part of the estimator state as shown below:

$$x = [ \begin{matrix}{b}_{0} \\ {b}_{a}\end{matrix} ]$$

the bias is assumed to be driven by two RRW noises

$$\dot{x} = [ \begin{matrix}{n}_{p , rrw} \\ {n}_{a , rrw}\end{matrix} ]$$

Following the Kalman filtering methodology, the estimator state and measurement equations in discrete-time domain can be written as:

$${x}_{k + 1} = {F}_{k} {x}_{k} + {w}_{k}$$

$${z}_{k} = {H}_{k} {x}_{k} + {v}_{k}$$

### Wherein

$${F}_{k} = {I}_{2 \times 2}$$

$${H}_{k} = {I}_{2 \times 2}$$

The measurements zₖ and the process and the measurement error covariances cov[wₖ]:=Qₖ and cov[νₖ]: =Rₖ are switching scheme dependent and shall be determined for each case as part of the estimation.

Making reference to FIG. 2B, at each discrete time step Δt, the measurement equation for the biases of the primary gyro and auxiliary gyro is dependent on where tₖ is in the switching cycle. For tₖ∈T₊ or tₛ_{ₐ}≤tₖ<tₛ_{ₐ}+T, the equation is

$${z}_{k} = [ \begin{matrix}{b}_{p , {s}_{a}} ( {t}_{k} ) \\ {b}_{a , {s}_{a}} ( {t}_{k} )\end{matrix} ] = \frac{1}{2} [ \begin{matrix}1 & 1 & - 1 & - 1 \\ - 1 & 1 & 1 & - 1\end{matrix} ] {ω}_{p / a , m} ( {t}_{k} - T , {t}_{k} ) + \frac{1}{2} [ \begin{matrix}- 1 & - 1 & 1 & 1 \\ 1 & - 1 & - 1 & 1\end{matrix} ] {η}_{p / a} ( {t}_{k} - T , {t}_{k} )$$

For tₖ∈T₋ or tₛ_{ₐ}−T≤tₖ<tₛ_{ₐ}, the equation is

$${z}_{k} = [ \begin{matrix}{b}_{p , {s}_{a}} ( {t}_{k} ) \\ {b}_{a , {s}_{a}} ( {t}_{k} )\end{matrix} ] = \frac{1}{2} [ \begin{matrix}1 & 1 & - 1 & - 1 \\ 1 & - 1 & - 1 & 1\end{matrix} ] {ω}_{p / a , m} ( {t}_{k} - T , {t}_{k} ) + \frac{1}{2} [ \begin{matrix}- 1 & - 1 & 1 & 1 \\ - 1 & 1 & 1 & - 1\end{matrix} ] {η}_{p / a} ( {t}_{k} - T , {t}_{k} )$$

where

$${ω}_{p / a , m} ( {t}_{k} - T , {t}_{k} ) = [ \begin{matrix}{ω}_{p , m} ( {t}_{k} - T ) \\ {ω}_{p , m} ( {t}_{k} ) \\ {ω}_{a , m} ( {t}_{k} - T ) \\ {ω}_{a , m} ( {t}_{k} )\end{matrix} ] ,$$

$${η}_{p / a} ( {t}_{k} - T , {t}_{k} ) = [ \begin{matrix}{n}_{p , arw} ( {t}_{k} - T ) \\ {n}_{p , arw} ( {t}_{k} ) \\ {n}_{a , arw} ( {t}_{k} - T ) \\ {n}_{a , arw} ( {t}_{k} )\end{matrix} ]$$

The process noise and measurement noise covariances are

$$cov [ {w}_{k} ] := {Q}_{k} = Δ t [ \begin{matrix}{Φ}_{p , rrw} & 0 \\ 0 & {Φ}_{a , rrw}\end{matrix} ]$$

$$cov [ {v}_{k} ] := {R}_{k} = \frac{1}{2 Δ t} ( {Φ}_{p , arw} + {Φ}_{a , arw} ) {I}_{2 \times 2}$$

Making reference to FIG. 2C, as described previously, bias measurements are performed at tₖ=tₛ_{ₐ} and tₖ=tₛ_{ₐ}+T instead of taking samples at each discrete time step Δt. At each mode switching time, the bias measurements are constructed using the averaged samples over the last two T windows. For tₖ=tₛ_{ₐ}+T, the measurement equation is

$${z}_{k} = [ \begin{matrix}{b}_{p , {s}_{a}} ( {t}_{k} ) \\ {b}_{a , {s}_{a}} ( {t}_{k} )\end{matrix} ] = \frac{1}{2} [ \begin{matrix}1 & 1 & - 1 & - 1 \\ - 1 & 1 & 1 & - 1\end{matrix} ] μ [ {ω}_{p / a , m} ( {T}_{\pm } ) ] + \frac{1}{2} [ \begin{matrix}- 1 & - 1 & 1 & 1 \\ 1 & - 1 & - 1 & 1\end{matrix} ] μ [ {η}_{p / a} ( {T}_{\pm } ) ]$$

For tₖ=tₛ_{ₐ}, the measurement equation is

$${z}_{k} = [ \begin{matrix}{b}_{p , {s}_{a}} ( {t}_{k} ) \\ {b}_{a , {s}_{a}} ( {t}_{k} )\end{matrix} ] = \frac{1}{2} [ \begin{matrix}1 & 1 & - 1 & - 1 \\ 1 & - 1 & - 1 & 1\end{matrix} ] μ [ {ω}_{p / a , m} ( {T}_{\pm } ) ] + \frac{1}{2} [ \begin{matrix}- 1 & - 1 & 1 & 1 \\ - 1 & 1 & 1 & - 1\end{matrix} ] μ [ {η}_{p / a} ( {T}_{\pm } ) ]$$

where

$$μ [ {ω}_{p / a , m} ( {T}_{\pm } ) ] = [ \begin{matrix}μ [ {ω}_{p , m} ( [ {t}_{k} - 2 T , {t}_{k} - T ) ) ] \\ μ [ {ω}_{p , m} ( [ {t}_{k} - T , {t}_{k} ) ) ] \\ μ [ {ω}_{a , m} ( [ {t}_{k} - 2 T , {t}_{k} - T ) ) ] \\ μ [ {ω}_{a , m} ( [ {t}_{k} - T , {t}_{k} ) ) ]\end{matrix} ] ,$$

$$μ [ {η}_{p / a} ( {T}_{\pm } ) ] = [ \begin{matrix}μ [ {n}_{p , arw} ( [ {t}_{k} - 2 T , {t}_{k} - T ) ) ] \\ μ [ {n}_{p , arw} ( [ {t}_{k} - T , {t}_{k} ) ) ] \\ μ [ {n}_{a , arw} ( [ {t}_{k} - 2 T , {t}_{k} - T ) ) ] \\ μ [ {n}_{a , arw} ( [ {t}_{k} - T , {t}_{k} ) ) ]\end{matrix} ]$$

In this case, the sample averaging takes place within T and the Klaman filter update step is also T. The process noise and measurement noise covariances are then

$$cov [ {w}_{k} ] := {Q}_{k} = T [ \begin{matrix}{Φ}_{p , rrw} & 0 \\ 0 & {Φ}_{a , rrw}\end{matrix} ]$$

$$cov [ {v}_{k} ] := {R}_{k} = \frac{1}{2 T} ( {Φ}_{p , arw} + {Φ}_{a , arw} ) {I}_{2 \times 2}$$

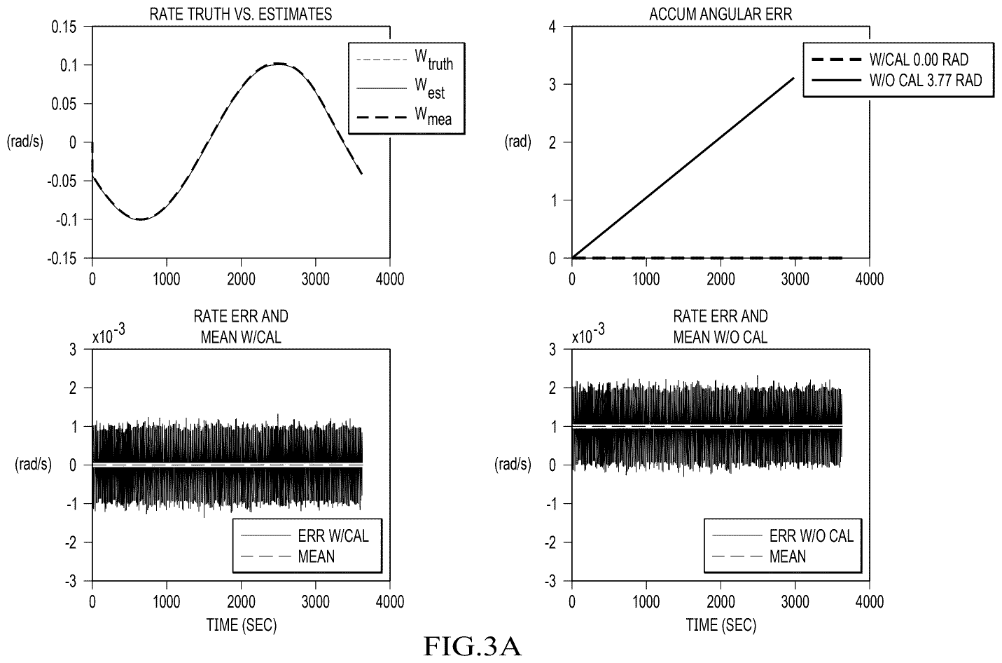

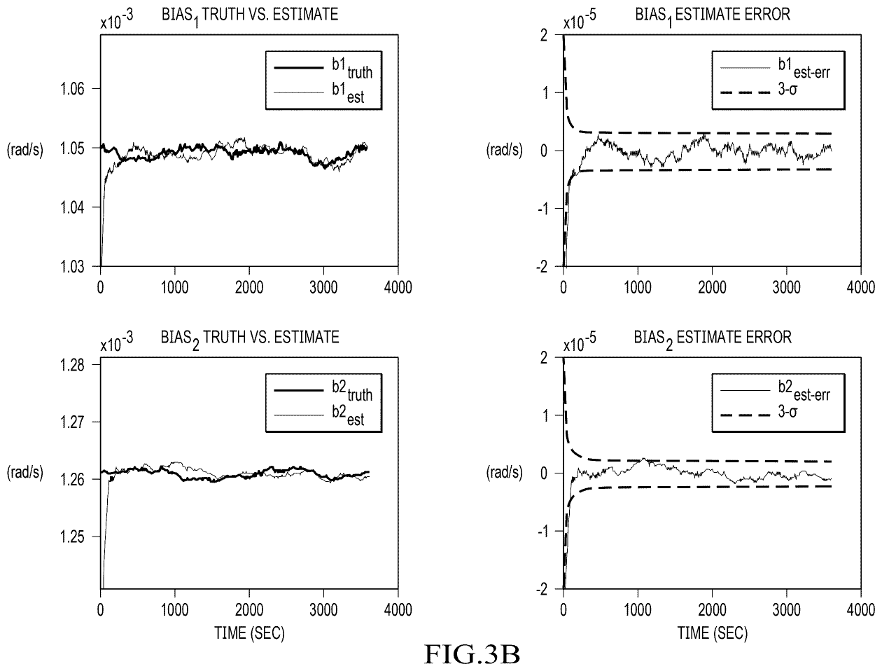

In order to highlight the performance of the disclosed methods and devices, the inventor has performed some simulations. In the simulations, the time step is set at Δt= 1/200 sec and the switching window T=0.5 sec. The primary gyro has parameters ARW=0.07/\sqrt{hr} [reference 7] and an assumed RRW=1.0°/hr/\sqrt{hr}. As for the auxiliary gyroscope, the relevant parameters are ARW=0.0033°/\sqrt{h}r and an assumed RRW=0.5°/hr/\sqrt{hr} [reference 2] with emulated and simplified mode switching capability. The reference truth motion profile is assumed to be sinusoidal with 0.1 rad/sec amplitude, zero offset, 1/3600 Hz frequency and a 35-degree phase angle. The long term (1 hour) angular rate profile, angular rate estimation error with and without the gyro self-calibration, and the integrated angular rate error (position error) with and without the gyro self-calibration are provided in FIG. 3A. The bias estimation performance from self-calibration is shown in FIG. 3B. The upper plots illustrate the embodiment previously described in relation to FIG. 2B, while the lower plots depict the embodiment associated with FIG. 2C. As shown in FIG. 3A, the application of the disclosed methods substantially improves and almost eliminates the average bias error. This improvement is also evident in the accumulated angular error, as illustrated by the plots in the top right of FIG. 3A.

According to certain embodiments, some advantages and unique characteristics of the disclosed methods and devices can be summarized as follows:
(a) The present teachings provide a continuous bias self-calibration scheme that doesn't rely on mutual calibration of two CVGs (which is the prior art);
(b) One CVG (auxiliary gyro) is enough to make the biases of many other normally operating gyros (CGV or non-CVGs) observable and calibratable;
(c) Normally operating other gyros (i.e., primary gyros) makes operation of gyro system simple and without possible loss of bandwidth due to mode switching transients;
(d) Support of non-CVG gyros opens door for using very inexpensive MEMS gyros;
(e) Support of multiple other gyros enables noise averaging benefit such that the gyro system has improved performance in both bias and noise. This is very significant as bias and noise affect navigation performance differently;
(f) Combined improvements in both bias and noise enables a potentially high performance gyro system using very low-cost and low SWaP gyros;
(g) Support of multiple gyros (in both auxiliary and primary sides) makes the gyro system inherently fault-tolerant, as failures in one or more gyros in either side result in only limited performance degradation (graceful degradation), a property very critical for many applications.

Several references [1]-[7] have been cited throughout the present disclosure and their information is provided in the paragraph below. All such references are incorporated herein by reference in their entirety.

### REFERENCES

[1] Scott Ploen, Jack Aldrich, David Bayard, Leonard Dorsky, Anup Katake, Edward Konefat, Carl Christian Liebe, and Joel Shields. Bias compensated inertial navigation for venus balloon missions. In IEEE Aerospace Conference, 2023.
[2] Anthony D. Challoner, Howard H. Ge, and John Y. Liu. Boeing disc resonator gyroscope. In IEEE/ION Position, Location and Navigation Symposium-PLANS 2014, 2014.
[3] Yong Liu and Anthony Dorian Challoner. Electronic bias compensation fora gyroscope, 2016.
[4] Alexander A. Trusov, Mark R. Phillips, George H. McCammon, David M. Rozelle, and A. Douglas Meyer. Continuously self-calibrating cvg system using hemispherical resonator gyroscopes. In 2015 IEEE International Symposium on Inertial Sensors and Systems (ISISS), 2015.
[5] D. Lynch. Vibratory gyro analysis by the method of averaging. In Proc. 2nd St. Petersburg Conf. on Gyroscopic Technology and Navigation, 1995.
[6] IEEE Std 1431-2004. Ieee standard specification format guide and test procedure for coriolis vibratory gyros.
[7] https://www.northropgrumman.com/wp-content/uploads/LN-200S-Inertial-MeasurementUnit-IMU-datasheet.pdf.

1. A gyroscope system comprising:
a primary gyroscope and an auxiliary gyroscope, the primary gyroscope being a single-mode gyroscope, and the auxiliary gyroscope being a mode-switching gyroscope, and
a bias estimator configured to:
receive measurements from the primary gyroscope and the auxiliary gyroscope at measurement time steps;
estimate biases of the primary gyroscope and the auxiliary gyroscope based on the measurements and a mode switching time of the auxiliary gyroscope to provide estimated biases, and
based on the estimated bias, output an angular velocity measurement for the primary gyroscope.

2. The gyroscope system of claim 1, wherein the estimated biases is provided at every time step of the measurements.

3. The gyroscope system of claim 2, wherein the estimated biases undergo continuous update based on:
a current measurement time step, and
an additional measurement time step preceding the current measurement time step.

4. The gyroscope system of claim 3, wherein the additional measurement time step:
precedes the current time step by a time equal to a duration of a switching time window of the auxiliary gyroscope, or
corresponds to a switching-mode preceding and different from the current switching-mode of the gyroscope.

5. The gyroscope system of claim 2, wherein the estimated biases undergo continuous update based on:
a current measurement time step, and
additional measurement time steps, the additional measurement time steps being in correspondence with switching-modes preceding and different from the current switching-mode of the gyroscope.

6. The gyroscope system of claim 3, wherein the bias estimate updates are performed regardless of an auxiliary gyroscope current switching mode of operation.

7. The gyroscope system of claim 1, wherein bias estimation is performed at a switching time of the auxiliary gyroscope.

8. The gyroscope system of claim 7, wherein the bias estimation is performed based on measurements performed during a current switching mode of the auxiliary gyroscope and a preceding switching mode of the auxiliary gyroscope.

9. The gyroscope system of claim 4, wherein bias estimation is performed using a Kalman filter.

10. The gyroscope system of claim 9, wherein the Kalman filter is updated at a rate of measurements.

11. The gyroscope system of claim 8, wherein the bias estimation is performed using a Kalman filter.

12. The gyroscope system of claim 11, wherein an updating period of the Kalman filter is equal to a duration of the switching mode of the auxiliary gyroscope.

13. The gyroscope system of claim 1, wherein the auxiliary gyroscope is a Coriolis Vibratory Gyroscope (CVG).

14. The gyroscope system of claim 1, wherein transient period of the mode switching is excluded when estimating biases.

15. An inertial measurement unit comprising:
a plurality of primary gyroscopes;
at least one auxiliary gyroscope being a mode-switching gyroscope, and
a bias estimator configured to:
receive measurements from the plurality of primary gyroscopes and the at least one auxiliary gyroscope at measurement time steps;
estimate biases of the plurality of primary gyroscopes and the at least one auxiliary gyroscope based on the measurements and the mode-switching time of the at least one auxiliary gyroscope to provide estimated biases;
based on the estimated biases, correct and output angular velocity measurements for the at least one auxiliary gyroscope, and the plurality of primary gyroscopes, and
based on weighted averaging of the bias-corrected angular velocity measurements for the at least one auxiliary gyroscope, and the plurality of primary gyroscopes, output a single angular velocity measurement for the inertial measurement unit system.

16. The inertial measurement unit of claim 15, wherein the bias estimator is provided through a Kalman filter to estimate the biases of all gyroscopes simultaneously.

17. The inertial measurement unit of claim 15, wherein the bias estimator is provided through a Kalman filter to estimate the biases of all gyroscopes and a current underlying host-body angular velocity simultaneously.

18. A method for self-calibrating a gyroscope system, the method comprising:
receiving measurements from a primary gyroscope, the primary gyroscope being a single-mode gyroscope;
receiving measurements from an auxiliary gyroscope, the auxiliary gyroscope being a mode-switching gyroscope;
switching the auxiliary gyroscope between at least two modes at predetermined intervals;
estimating biases of the primary gyroscope and the auxiliary gyroscope based on received measurements and mode-switching of the auxiliary gyroscope to provide estimated biases, and
outputting corrected angular velocity measurements for the primary gyroscope, and the auxiliary gyroscope.

19. The method of claim 18, further comprising updating the estimated biases at every measurement time step using current measurements and measurements from a predetermined time in the past.

20. The method of claim 19, wherein the predetermined time in the past is equal to a duration of a mode-switching window of the auxiliary gyroscope.

21. The method of claim 18, further comprising updating the estimated biases at mode-switching times using averaged measurements from two consecutive mode switching windows.

22. The method of claim 18, wherein estimating the biases comprises implementing a Kalman filter to estimate the biases of the primary gyroscope and the auxiliary gyroscope simultaneously.

23. The method of claim 18, wherein the primary gyroscope has better noise performance characteristics than the auxiliary gyroscope.

24. The method of claim 18, further comprising combining the bias corrected measurements of the at least one auxiliary gyroscope and of the plurality of primary gyroscopes to produce angular velocity measurements of the gyro system.

25. The method of claim 24, wherein the combining step is based on a noise performance improvement of the gyroscope system.
